(19) United States
(12) Patent Application Publication
(10) Pub. No.: US 2008/0022353 A1
(43) Pub. Date: Jan. 24, 2008

(54) Framework to simplify security engineering

(75) Inventors: Frank Mayer, Ellicott City, MD (US); Karl MacMillan, Baltimore, MD (US); Art Wilson, Olney, MD (US); James Athey, Washington, DC (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Tresys Technology, LLC

(21) Appl. No.: 11/367,721

(22) Filed: Mar. 6, 2006

(51) Int. Cl. H04L 9/00

(52) U.S. Cl. 726/1

(57) ABSTRACT

A method and a computer program product are disclosed for developing a security-enhanced application that runs on a flexible and configurable mandatory access control (MAC) operating system. The security-enhanced application separates resource information from processes and processes from each other. The security-enhanced application also includes a set of rules that control information flow between the resource information and processes. The method includes the following. First, user input is received that represents at least one abstract security principle. Then, the user input is translated into policy language using a framework dictionary, wherein the policy language specifies a policy that determines allowed access for the flexible and configurable MAC operating system.

### STATEMENT REGARDING FEDERALLY-SPONSORED RESEARCH AND DEVELOPMENT

The U.S. government has a paid-up license in this invention and the right in limited circumstances to require the patent owner to license others on reasonable terms as provided for by the terms of contract no. DA342-0158-06 awarded by the National Security Agency.

### BACKGROUND OF THE INVENTION

1. Field of the Invention

The present invention is generally directed to the development of security-enhanced computer applications, and more particularly to the development of security-enhanced computer applications that run on flexible and configurable mandatory access control (MAC) computer operating systems.

2. Background

An access control mechanism is a type of computer security that is enforced by an operating system. There are two major kinds of access control mechanisms-discretionary access control (DAC) and mandatory access control (MAC). In DAC, system resources (such as files) and applications (such as programs) each have security attributes associated with them. An application's access to system resources is controlled by the operating system based on these security attributes. A user may affect changes to these security attributes, which in turn means that an application may affect changes to these security attributes. As a result, an application may change security attributes of a system resource and/or application, thereby creating a security vulnerability. In MAC, access to system resources cannot be affected by actions of individual applications during normal computing operations. In this way, MAC offers a greater level of security compared to DAC.

An example of a MAC mechanism is the Multi-Level Security (MLS) mechanism. The MLS mechanism is modeled after the government's classification of information in terms of “public,” “secret,” and “top secret.” In MLS, each application and each system resource is labeled with a level denoting its relative sensitivity. Applications can generally read and write to system resources at the same sensitivity level. In addition, an application can read lower level system resources and write to higher level system resources. However, an application may never read higher level system resources nor write to lower level system resources. The idea being that information can flow from lower levels to higher levels, but not the reverse, thereby protecting the confidentiality of the higher level data. The goal of a MLS mechanism is to protect sensitive data. In other words, the MLS mechanism is an example of an inflexible MAC mechanism.

Type enforcement (TE) is another example of a MAC mechanism. TE is implemented, for example, in security-enhanced Linux (SELinux). In TE, applications and system resources are assigned a type. Access for a TE system is defined by a collection of rules contained in a file called a policy. The policy file is loaded into the kernel during the boot process. In many ways, TE is an improvement over MLS because the policy is not hard-coded or predefined in the kernel. In TE, the policy may be modified to suit a particular solution. In this way, TE is an example of a flexible and configurable MAC mechanism.

Although TE provides a flexible and configurable MAC mechanism, configuring the policy is difficult. The policy language includes many complexities, including class inheritances and kernel details. These complexities must be understood by a system developer in order to develop an effective security-enhanced application. However, many system developers do not have such an understanding of the policy language. Therefore, many system developers cannot take advantage of the security capabilities offered by TE.

Given the foregoing, what is needed then is a set of tools and features for developing a security-enhanced application that runs on a flexible and configurable MAC operating system and that does not require understanding of the complicated policy language. Such a set of tools and features should enable a user to develop the security-enhanced application using abstract security principles that are intuitively and graphically represented.

### BRIEF SUMMARY OF THE INVENTION

In accordance with an embodiment of the present invention there is provided a set of tools and features for developing a security-enhanced application that runs on a flexible and configurable MAC operating system and that does not require understanding of the complicated policy language. This set of tools and features enables a user to develop the security-enhanced application using abstract security principles that are intuitively and graphically represented.

According to an embodiment of the present invention there is provided a method for developing a security-enhanced application that runs on a flexible and configurable MAC operating system. The security-enhanced application separates resource information from processes, and processes from each other. The security-enhanced application also includes a set of rules that control information flow between the information resources and processes. The method includes the following steps. First, input is received from a user that represents at least one abstract security principle. Then, the input is translated into policy language using a framework dictionary, wherein the policy language specifies a policy that determines allowed access for the flexible and configurable MAC operating system.

According to another embodiment of the present invention there is provided a computer program product including a computer usable medium having control logic stored therein for developing a security-enhanced application that runs on a flexible and configurable MAC operating system. The security-enhanced application separates resource information from processes, and processes from each other. The security-enhanced application also includes a set of rules that control information flow between the information resources and processes. The control logic includes first and second computer readable program code. The first computer readable program code causes the computer to receive input from a user that represents at least one abstract security principle. The second computer readable program code causes the computer to translate the input into policy language using a framework dictionary, wherein the policy language specifies a policy that determines allowed access for the flexible and configurable MAC operating system.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 depicts a block diagram illustrating an overview of a method for developing a security-enhanced application in accordance with an embodiment of the present invention.

FIGS. 2A, 2B, and 2C depict block diagrams illustrating abstract security principles of a conceptual framework in accordance with an embodiment of the present invention.

FIG. 3 depicts a block diagram illustrating an example configuration of abstract security principles in accordance with an embodiment of the present invention.

FIG. 4 depicts a block diagram representing declarations written in a framework language in accordance with an embodiment of the present invention.

FIG. 5 depicts a block diagram illustrating an example configuration of abstract security principles in accordance with an embodiment of the present invention.

FIG. 6 is a block diagram of a computer system on which an embodiment of the present invention may be executed.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

I. Overview

The present invention is directed to features and tools for developing a security-enhanced application that runs on a flexible and configurable mandatory access control (MAC) computer operating system. The security-enhanced application is such that it separates information resources from processes, and processes from each other. The security-enhanced application also specifies rules that control information flow between the information resources and processes. Throughout the specification, the features and tools are described generally in terms of a Linux operating system and in particular in terms of security-enhanced Linux (SELinux). The invention is not, however, limited to the Linux operating system or SELinux. Based on the description herein, one skilled in the relevant art(s) will understand that the security enhancement features and tools can be implemented on other flexible and configurable MAC operating systems as well.

A security-enhanced application developed in accordance with the present invention may be used to generate a security solution for any system or collection of systems in which information must flow through stages in a particular order, such as a cross domain solution (CDS). A CDS is an application or set of applications that perform two functions. First, a CDS isolates networks having different information sensitivities or integrity. Second, a CDS controls information flow between the networks, wherein the information must flow through one or more filter processes, such as a virus scan or a keyword filter. Although particularly suited for generating such solution types, the present invention is not limited to these solution types. Based on the description herein, one skilled in the relevant art(s) will understand how to generate other solution types using an embodiment of the present invention.

It is noted that references in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Conventional security engineering in SELinux is difficult. Embodiments of the present invention provide features and tools that enable a user to develop SELinux applications in a simplified and intuitive manner. Using these features and tools, the user is not required to understand SELinux policy nuances and Linux kernel details to develop a SELinux application.

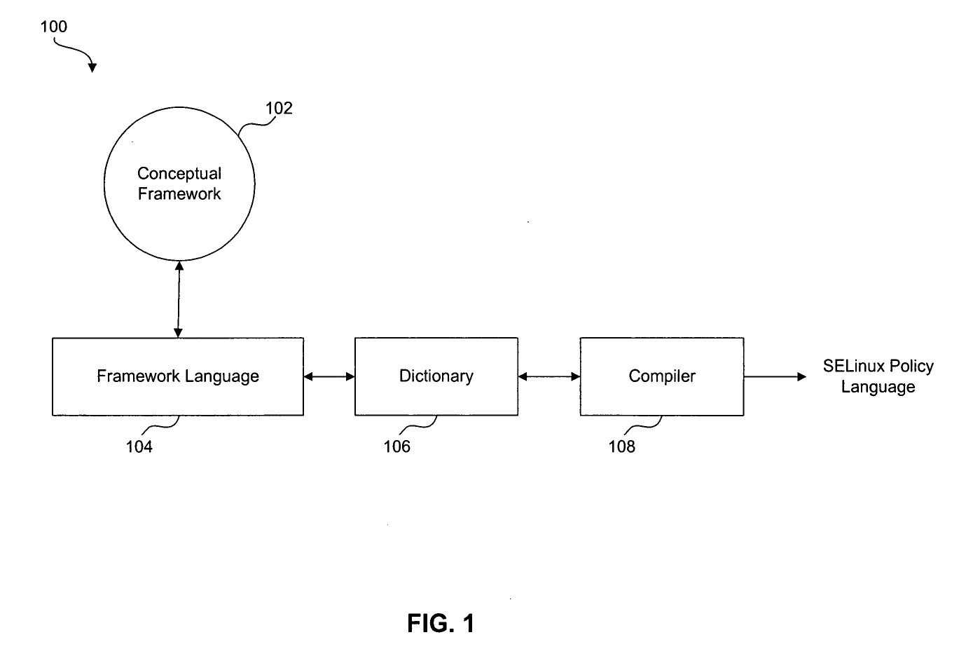

FIG. 1 is a block diagram 100 illustrating an overview of components associated with security engineering in accordance with an embodiment of the present invention. Block diagram 100 includes a conceptual framework 102, a framework language 104, a dictionary 106, and a compiler 108. The conceptual framework 102 offers a user an intuitive concept space in which to develop an appropriate security-enhanced application. The framework language 104 expresses the abstract security principles contained in the conceptual framework 102 in an intuitive language. The dictionary 106 maps between the intuitive expressions contained in the framework language 104 and the SELinux policy language. The compiler 108 translates expressions written in the framework language 104 into SELinux policy language using the dictionary 106.

II. Conceptual Framework

The conceptual framework is an abstract concept space that allows a user to think in terms of abstract security principles. SELinux policy language is complex, including many nuances associated with, for example, class inheritances and Linux kernel details. The conceptual framework abstracts the complexities of SELinux policy language into simplified and intuitive concepts, which can be easily understood without knowledge of SELinux policy language. The conceptual framework includes three basic concepts—domains, shared resources, and access.

A. Basic Concepts

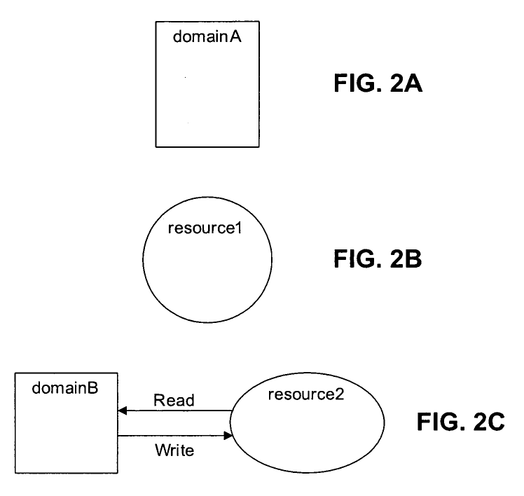

A domain is security boundary that may contain many different kinds of system objects. Examples of system objects included in a domain can be, but are not limited to, active entities such as processes, passive objects such as files and sockets, transition objects such as file entry points, and other similar system objects as would be apparent to a person skilled in the relevant art(s). Domains are graphically represented in the conceptual framework as boxes, as shown in FIG. 2A. As described in more detail below, there are several different kinds of domains, including sub-domains and base domains.

A shared resource is a passive object used for information flow between domains. In the conceptual framework, information contained in a first domain must flow through a shared resource before this information can be accessed by a second domain. In this way, information does not flow directly from one domain to another domain. Shared resources are graphically represented in the conceptual framework as circles, as shown in FIG. 2B. As described in more detail below, there are several different kinds of shared resources, including base resources and controlled resources.

Access refers to the type of connection between a domain and a shared resource. The most common types of connections include read and write. The general concept of a read allows a domain to access information from a shared resource. As described in more detail below, the specific instantiation of a read will depend on the types of domains and shared resources that are used. The general concept of a write allows a domain to put information into a shared resource. Similar to the read operation, the specific instantiation of a write will depend on the types of domains and shared resources that are used, as described in more detail below. A read is graphically represented in the conceptual framework as an arrow pointing away from a shared resource and a write is graphically represented as an arrow pointing toward a shared resource, as shown in FIG. 2C.

B. Decomposition

The concepts of a domain, a shared resource, and access offer an abstract, but comprehensive, representation of security principles. A particularly important security principle that these abstract concepts capture is Decomposition. Decomposition allows a domain to be decomposed into sub-domains, which can each be connected to a shared resource with a particular kind of access. Importantly, implied constraints are imposed on each sub-domain so that it can only have access or resources that its parent domain has.

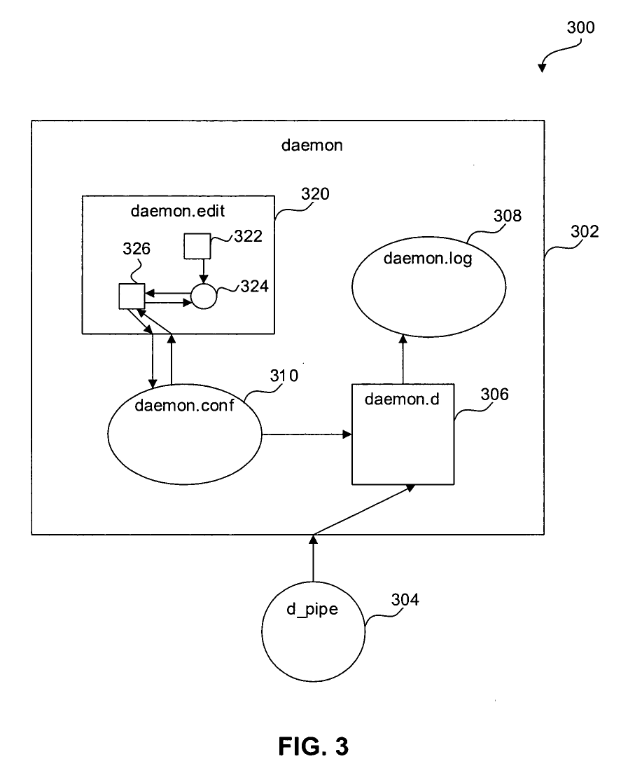

FIG. 3 depicts a block diagram 300 that graphically illustrates the principle of decomposition. Block diagram 300 includes a domain daemon 302 and a shared resource d_pipe 304. The domain daemon 302 has read access, but not write access, to the shared resource d_pipe 304. In addition, the domain daemon 302 is decomposed into a sub-domain daemon.d 306 that has read access to shared resource d_pipe 304. Sub-domain daemon.d 306 has write access to a shared resource daemon.log 308, and has read access to a shared resource daemon.conf 310. Domain daemon 302 also includes a second sub-domain—sub-domain daemon.edit 320—which has read and write access to daemon.conf 310. As shown in FIG. 3, sub-domain daemon.edit 320 can be further decomposed into sub-sub-domains and shared resources.

The concept of implied constraints imposed on sub-domains can be understood with reference to block diagram 300. As mentioned above, domain daemon 302 only has read access to shared resource d_pipe 304. As a result, sub-domain daemon.d 306 can only have read access to shared resource d_pipe 304. In other words, sub-domain daemon.d 306 is not entitled to write access to shared resource d_pipe 304 because its parent domain (i.e., domain daemon 302) does not have write access. By limiting access in this way, decomposition provides granular control of communications between domain elements and external shared resources. In addition, decomposition offers a hierarchical representation of domains, which allows a user to visualize the system at any level and to any depth.

In sum, the conceptual framework provides a user with a concept space in which to think of and visualize abstract security principles that can be used to develop a security-enhanced application. In an embodiment, a user may develop a security-enhanced application using a graphical depiction of domains, shared resources, and access, without being required to input text. Additionally or alternatively, the user may develop a security-enhanced application by inputting text that expresses the abstract security principles represented in the conceptual framework. These abstract security principles are expressed in the framework language.

III. Framework Language

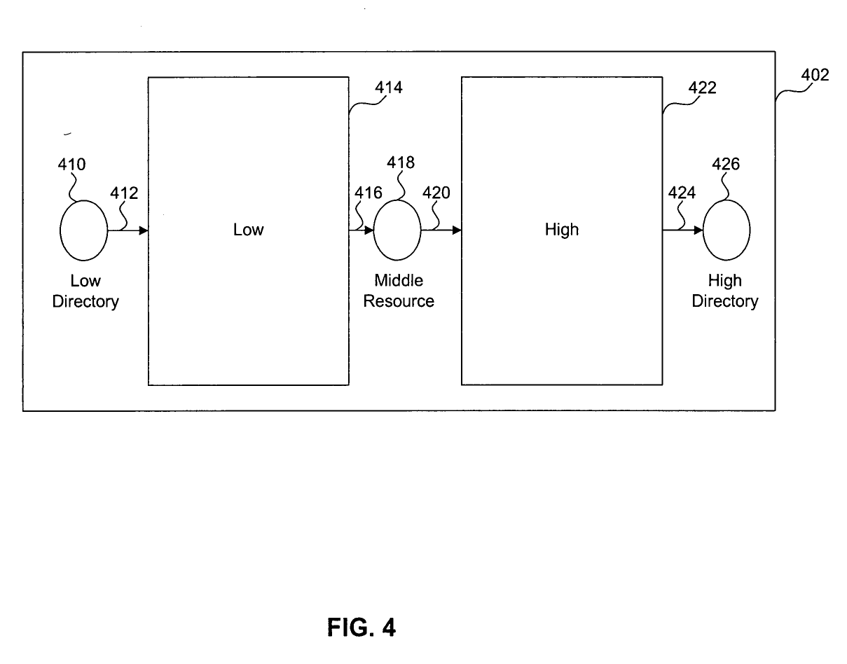

The framework language is an intuitive language that is tied to the abstract security principles embodied in the conceptual framework. The framework language offers a vocabulary of abstract security principles (e.g., domains, shared resources, and access) and an intuitive syntax for declaring each type of abstract security principle. A user may develop a security application using the framework language without knowledge of SELinux policy language. The framework language can then be translated into SELinux policy language. Shown below are lines of code written in the framework language that generate the security configuration illustrated by block diagram 402 of FIG. 4.

| | |
|---|---|
| 1. | domain Low; |
| 2. | domain High; |
| 3. | |
| 4. | resource LowDir { dirFiles }; |
| 5. | resource HighDir { dirFiles }; |
| 6. | resource MiddleResource { unixStreamSockets }; |
| 7. | |
| 8. | access Low LowDir read; |
| 9. | access Low MiddleResource write; |
| 10. | access High MiddleResource read; |
| 11. | access High HighDir write; |

Each line of code includes a declaration (such as domain, resource, or access) and a name associated with that declaration (such as “Low,” “High,” “LowDir,” and “HighDir”). A semicolon indicates the termination of a line of code. A line of code may also include a resource definition (“rdef”) (such as, dirFiles and unixStreamSocket) within curly brackets. Rdefs are groupings of Linux kernel objects. Rdefs will be described in more detail below, for example, in Section IV.

The first line of code declares a domain called “Low,” which is illustrated by box 414 in block diagram 402. Similarly, the second line of code declares a domain called “High,” which is illustrated by box 416 in block diagram 402.

The shared resources that connect to domains High and Low are declared by the fourth, fifth, and sixth lines of code. The third line of code declares a shared resource called “LowDir,” which is illustrated by circle 410 in block diagram 402. The declaration in the third line includes the syntax “dirFiles” within the brackets. As mentioned above, this syntax is an rdef, which defines the type or types of Linux kernel objects that are included in resource LowDir. The fifth and sixth lines of code declare shared resources illustrated by circle 426 and circle 418, respectively.

Access between the domains and shared resources are declared in lines 8 through 11. In particular, lines 8 and 9 declare the access granted to domain Low 414 and lines 10 and 11 declare the access granted to domain High 422. Line 8 declares that domain Low 414 has read access to shared resource LowDir 410, as indicated by arrow 412. Similarly, line 9 declares that domain Low 414 has write access to shared resource MiddleResource 418, as indicated by arrow 416. Line 10 declares that domain High 422 has read access to shared resource MiddleResource 418, as indicated by arrow 420. Finally, line 11 declares that domain High has write access to shared resource HighDir 426, as indicated by arrow 424.

As mentioned above, the framework language is intuitive language tied to the abstract security principles in the conceptual framework and does not require knowledge of SELinux policy language. The framework language is translated into SELinux policy language using the dictionary.

IV. Dictionary

The dictionary offers a mapping between the framework language and SELinux policy language. The dictionary is used to translate the framework language into SELinux policy language. In addition, the dictionary (i) defines the kinds of domains and share resources available to a user, (ii) defines the access rights between a particular kind of domain and a particular kind of shared resource, and (iii) allows a user to expand the available kinds of domains and shared resources. These ideas will be explained with reference to the example dictionary definitions provided below.

| | |
|---|---|
| 1. | rdef dirFiles { |

| | |
|---|---|
| 2. | [desc: Regular files and directories] |
| 3. | classes { file dir } |
| 4. | read { |

| | |
|---|---|
| 5. | default read { |

| | |
|---|---|
| 6. | [desc: open, read, and stat access] |
| 7. | [weight: 10] |
| 8. | file { read getattr } |
| 9. | dir { read search getattr } |

| | |
|---|---|
| 10. | } |
| 11. | stat { |

| | |
|---|---|
| 12. | [desc: stat / get attributes] |
| 13. | [weight: 2] |
| 14. | file { getattr } |
| 15. | dir { getattr } |

| | |
|---|---|
| 16. | } |

| | |
|---|---|
| 17. | } |

| | |
|---|---|
| 18. | } |

Generally speaking, this code includes a resource definition (“rdef”) that links the abstract security principles to SELinux kernel objects. Line 1 indicates that this is an rdef of a collection of objects called dirFiles. This rdef defines two things with respect to dirFiles. First, the rdef defines what dirFiles are in terms of SELinux kernel objects. In particular, line 3 declares that dirFiles includes the SELinux kernel objects “file” and “dir.” Second, the rdef defines what read access means in terms of SELinux kernel objects, which is declared in lines 4 through 17. Line 4 indicates that a definition of read will follow. In line 5, a “default read” access is declared. Line 7 declares the “size” of the read pipe, which is measured on a scale of 0 to 10. Then, lines 8 and 9 specify what “default read” means for the SELinux classes (e.g., “file”) in terms of SELinux permissions (e.g., “read” and “getattr”). Similarly, in line 11, a “stat” access is declared. Line 13 declares the “size” of the read pipe. Then, lines 14 and 15 specify what “stat” means for SELinux classes (e.g., “file”) in terms of SELinux permissions (e.g., “getattr”).

The dictionary is used by the compiler to translate the framework language into SELinux policy language resulting in policy statements. For a system to work properly, these policy statements must be integrated with an underlying based policy of the operating system. The base policy defines the core security properties upon which the security-enhanced application will run. The particular manner in which the policy statements are linked with the base policy will differ from one base policy to another. For example, linking with a base policy may include adding attributes to object or subject types generated during the translation or calling a base policy macro to access base types. However, the present invention is not limited to these types of linking methods. Other linking methods may be implemented without deviating from the spirit and scope of the present invention as would be apparent to a person skilled in the relevant art(s).

In addition to translating the framework language, the dictionary also defines the kinds of domains and shared resources available to a user. For example, based on the lines of code above, the only available kind of domains and shares resources would be “dirFiles.” The dictionary, however, usually includes more lines of code than the illustrative lines presented above. Consequently, there would usually be other kinds of domains and shared resources available to a user. The user may also expand the kinds of domains and shared resources, as described below.

Furthermore, the dictionary defines the kinds of access available between the different kinds of domains and shared resources. Based on the example code from above, a user may choose two different kinds of read access—“default read” or “stat.” The user may also define other kinds of access, including read access, write access or some other kind of access.

Still further, the dictionary may be expanded by a user to include more kinds of domains, shared resources, and access, as alluded to above. The features and tools of the present invention, including the dictionary, may be implemented on an open source operating system, such as Linux. In an embodiment in which the dictionary is implemented in open source code, a user can modify the dictionary to include an rdef that was not originally included in the dictionary. As a result, the user can link the abstract security principles of the conceptual framework to an SELinux kernel object or collection of objects in a manner that was not originally specified in the dictionary. In this way, a user may adapt the features and tools of the present invention to develop a particular kind of security-enhanced application or generate a particular kind of solution.

V. Illustrative Example

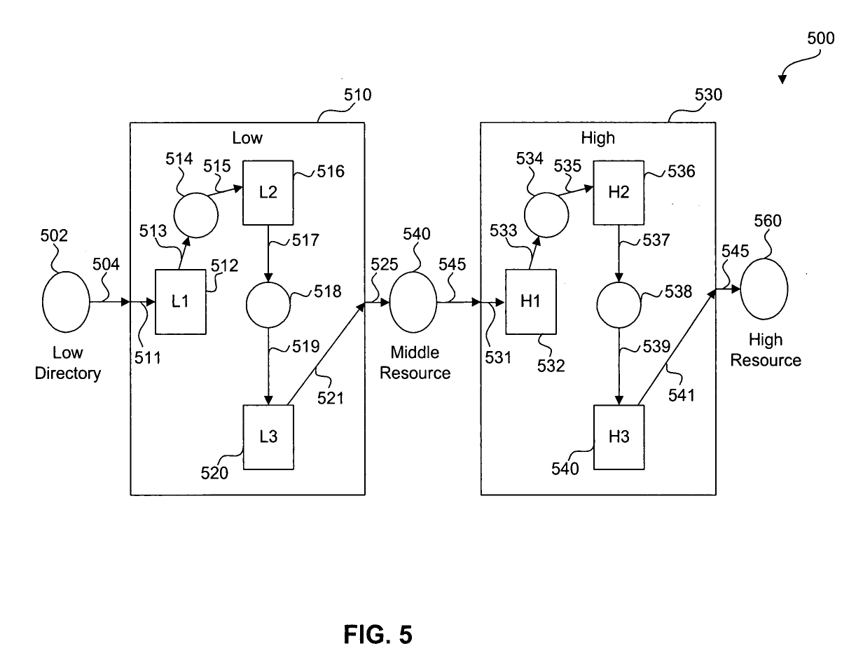

As mentioned above, the features and concepts described above may be used to generate a security-enhanced application that runs on a flexible and configurable MAC operating system. For example, FIG. 5 depicts a block diagram 500 of an example configuration of a security-enhanced application that may be generated using the features and concepts of the present invention. The configuration in FIG. 5 will be used to summarize features and concepts introduced above, and to introduce additional features and concepts of embodiments of the present invention. This example configuration is described for illustrative purposes only, and not limitation. Other configurations may be generated using the features and concepts of the present invention.

Block diagram 500 includes a domain called Low and a domain called High, represented by boxes 510 and 530, respectively. In addition, block diagram 500 includes a shared resource called Low Directory, a shared resource called Middle Resource, and a shared resource called High Resource, represented by circles 502, 540, and 560, respectively. The Low domain 510 has read access to Low Directory 502 and write access to Middle Resource 540, as indicated by arrows 504 and 525, respectively. High domain 530 has read access to Middle Resource 540 and write access to High Resource 560, as indicated by arrows 545 and 555, respectively. In addition, Low domain 510 and High domain 530 are each decomposed into other domains and shared resources.

In an embodiment, a user may generate a security-enhanced application represented by block diagram 500 by manipulating graphical representations of the concepts of domains, shared resources, and access. The user may create block diagram 500 by interacting with a graphical user interface. After the user creates such a graphical representation, a tool in accordance with this embodiment would implicitly generate the framework language that corresponds to the graphical representation. Then, the compiler would translate the framework language into policy language that specifies a policy that defines access on the flexible and configurable MAC operating system on which the security-enhanced application is to run.

In another embodiment, the user may generate a security-enhanced application represented by block diagram 500 by inputting declarations written in the framework language that expresses the concepts of domains, shared resources, and access. For example, the text provided below may be received as input. Then, the compiler would translate the text into policy language, similar to that described above.

| | |
|---|---|
| 1. | # Systems Engineer policy |
| 2. | domain Low { namedPipes unixDatagramSockets }; |
| 3. | domain High { dirFiles namedPipes }; |
| 4. | |
| 5. | resource LowDir { dirFiles }; |
| 6. | resource HighDir { dirFiles }; |
| 7. | resource MiddleResource { unixStreamSockets }; |
| 8. | |
| 9. | access Low LowDir read; |
| 10. | access Low MiddleResource write; |
| 11. | access High MiddleResource read; |
| 12. | access High HighDir write; |
| 13. | |
| 14. | # Developer Policy |
| 15. | |
| 16. | domain Low.L1; |
| 17. | domain Low.L2; |
| 18. | domain Low.L3; |
| 19. | domain High.H1; |
| 20. | domain High.H2; |
| 21. | domain High.H3; |
| 22. | |
| 23. | resource Low.R1 { namedPipes }; |
| 24. | resource Low.R2 { unixDatagramSockets }; |
| 25. | resource High.R1 { dirFiles }; |
| 26. | resource High.R2 { namedPipes }; |
| 27. | |
| 28. | access Low.L1 LowDir read; |
| 29. | access Low.L1 Low.R1 write; |
| 30. | access Low.L2 Low.R1 read; |
| 31. | access Low.L2 Low.R2 write; |
| 32. | access Low.L3 Low.R2 read; |
| 33. | access Low.L3 MiddleResource write; |
| 34. | access High.H1 MiddleResource read; |
| 35. | access High.H1 High.R1 write { dirFiles : append ); |
| 36. | access High.H2 High.R1 read; |
| 37. | access High.H2 High.R2 write; |
| 38. | access High.H3 High.R2 read; |
| 39. | access High.H3 HighDir write; |
| 40. | access High.H1 High.R1 read; |

To create a conceptual framework that models inter-domain communication strictly via shared resources, there are special kinds of shared resources. In SELinux, certain object classes are assigned the same label as the creating process type. Examples of these objects include, but are not limited to, sockets, message queues, and signals. These objects cannot be placed in resource definitions and separated from the creating domain because the objects and the creating domain each share the same type. To handle these objects without allowing a domain to communicate directly with another domain, the conceptual framework includes a special kind of shared resource, called a controlled resource. A controlled resource is always linked to the creating domain. Conceptually, a controlled resource is a passive facilitator of communication between domains, just like shared resources.

In addition to controlled resources, a special resource, called “entry point,” is included in the conceptual framework to prevent domains from directly communicating with each other. For example, in some situations a first domain must start a second domain. To prevent the first domain from directly communicating with the second domain, an entry point resource is placed between the two domains. In this way, information from the first domain flows through the entry point resource before going to the second domain, thereby preventing the two domains from directly communicating with each other.

Furthermore, the tools and features of the present invention allow pre-existing objects and processes to be used to generate a security-enhanced application. For example, a pre-existing virus scanning application, which was written in SELinux policy language, can be incorporated with domains and shared resources created using tools of the present invention to generate a security-enhanced application. To illustrate this idea, suppose box 414 in FIG. 4 represents a pre-existing virus scanning application that is to be linked to a domain called High represented by 422. To incorporate the virus scanning application into a security-enhanced application using the framework language, the virus scanning application can be declared using the declaration “base domain.” The label “base” in this declaration indicates to the compiler that the domain has a pre-existing policy associated with it. The compiler will then use macros to wrap the pre-existing policy so it can be incorporated with the other domains and shared resources declared in the framework language. In this way, the pre-existing policy and the other domains and shared resources may be integrated with the base policy of the operating system. In a similar manner to a base domain, a base resource may also be declared.

VI. Example Computer System Implementation

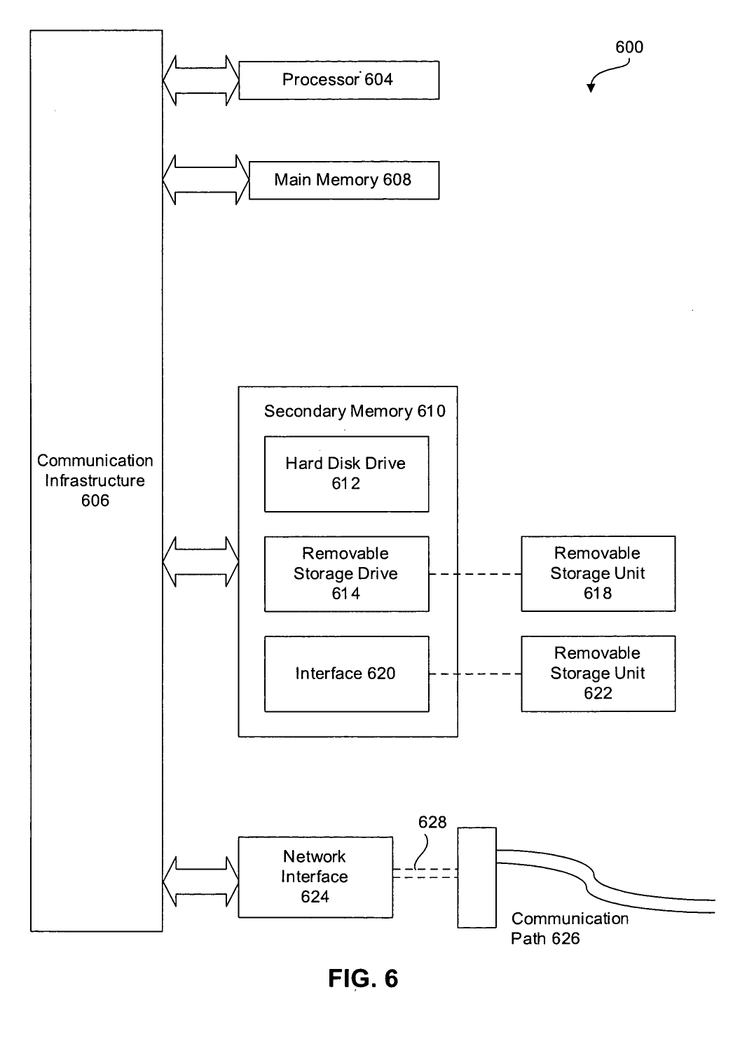

Various aspects of the present invention can be implemented by software, firmware, hardware, or a combination thereof. FIG. 6 illustrates an example computer system 600 in which an embodiment of the present invention, or portions thereof, can be implemented as computer-readable code. Various embodiments of the invention are described in terms of this example computer system 600. After reading this description, it will become apparent to a person skilled in the relevant art how to implement the invention using other computer systems and/or computer architectures.

Computer system 600 includes one or more processors, such as processor 604. Processor 604 can be a special purpose or a general purpose processor. Processor 604 is connected to a communication infrastructure 606 (for example, a bus or network).

Computer system 600 also includes a main memory 608, preferably random access memory (RAM), and may also include a secondary memory 610. Secondary memory 610 may include, for example, a hard disk drive 612 and/or a removable storage drive 614. Removable storage drive 614 may comprise a floppy disk drive, a magnetic tape drive, an optical disk drive, a flash memory, or the like. The removable storage drive 614 reads from and/or writes to a removable storage unit 618 in a well known manner. Removable storage unit 618 may comprise a floppy disk, magnetic tape, optical disk, etc. which is read by and written to by removable storage drive 614. As will be appreciated by persons skilled in the relevant art(s), removable storage unit 618 includes a computer usable storage medium having stored therein computer software and/or data.

In alternative implementations, secondary memory 610 may include other similar means for allowing computer programs or other instructions to be loaded into computer system 600. Such means may include, for example, a removable storage unit 622 and an interface 620. Examples of such means may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to computer system 600.

Computer system 600 may also include a communications interface 624. Communications interface 624 allows software and data to be transferred between computer system 600 and external devices. Communications interface 624 may include a modem, a network interface (such as an Ethernet card), a communications port, a PCMCIA slot and card, or the like. Software and data transferred via communications interface 624 are in the form of signals 628 which may be electronic, electromagnetic, optical, or other signals capable of being received by communications interface 624. These signals 628 are provided to communications interface 624 via a communications path 626. Communications path 626 carries signals 628 and may be implemented using wire or cable, fiber optics, a phone line, a cellular phone link, an RF link or other communications channels.

In this document, the terms “computer program medium” and “computer usable medium” are used to generally refer to media such as removable storage unit 618, removable storage unit 622, a hard disk installed in hard disk drive 612, and signals 628. Computer program medium and computer usable medium can also refer to memories, such as main memory 608 and secondary memory 610, which can be memory semiconductors (e.g. DRAMs, etc.). These computer program products are means for providing software to computer system 600.

Computer programs (also called computer control logic) are stored in main memory 608 and/or secondary memory 610. Computer programs may also be received via communications interface 624. Such computer programs, when executed, enable computer system 600 to implement the present invention as discussed herein. In particular, the computer programs, when executed, enable processor 604 to implement the processes of the present invention. Accordingly, such computer programs represent controllers of the computer system 600. Where the invention is implemented using software, the software may be stored in a computer program product and loaded into computer system 600 using removable storage drive 614, interface 620, hard drive 612 or communications interface 624.

The invention is also directed to computer products comprising software stored on any computer useable medium. Such software, when executed in one or more data processing device, causes a data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

### CONCLUSION

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

What is claimed is:

1. A method for developing a security-enhanced application that runs on a flexible and configurable mandatory access control (MAC) operating system, wherein the security-enhanced application separates information resources from processes and processes from each other, and wherein the security-enhanced application includes a set of rules that control information flow between the information resources and processes, the method comprising:
(a) receiving input from a user that represents at least one abstract security principle; and
(b) translating the input into policy language using a framework dictionary, wherein the policy language specifies a policy that determines allowed access for the flexible and configurable MAC operating system.

2. The method of claim 1, wherein the receiving step comprises:
receiving a graphical depiction of the at least one abstract security principle.

3. The method of claim 1, wherein the receiving step comprises:
receiving at least one declaration written in a framework language that expresses the at least one abstract security principle.

4. The method of claim 1, wherein the receiving step comprises:
receiving at least one declaration written in a framework language that expresses at least one abstract security principle, wherein the at least one declaration declares a domain which represents a security boundary.

5. The method of claim 4, wherein the receiving step further comprises:
receiving at least one declaration written in a framework language that expresses at least one abstract security principle, wherein the at least one declaration further declares the domain in terms of at least one kernel object.

6. The method of claim 5, wherein the receiving step further comprises:
receiving at least one declaration written in a framework language that expresses at least one abstract security principle, wherein the at least one declaration further declares a sub-domain which is constrained by (i) a subset of the at least one kernel object declared for the domain and (ii) access rights granted to the domain.

7. The method of claim 1, wherein the receiving step comprises:
receiving at least one declaration written in a framework language that expresses at least one abstract security principle, wherein the at least one declaration declares a base domain which represents a security boundary.

8. The method of claim 1, wherein the receiving step comprises:
receiving at least one declaration written in a framework language that expresses at least one abstract security principle, wherein the at least one declaration declares a shared resource which allows a first domain to interact with a second domain.

9. The method of claim 8, wherein the receiving step further comprises:
receiving at least one declaration written in a framework language that expresses at least one abstract security principle, wherein the at least one declaration further declares the shared resource in terms of at least one kernel object.

10. The method of claim 1, wherein the receiving step comprises:
receiving at least one declaration written in a framework language that expresses at least one abstract security principle, wherein the at least one declaration declares a base resource which allows a first domain to interact with a second domain.

11. The method of claim 1, wherein the receiving step comprises:
receiving at least one declaration written in a framework language that expresses at least one abstract security principle, wherein the at least one declaration declares an access right which specifies a general kind of connection between a domain and a shared resource, wherein the general kind of connection includes at least one of a read, a write, or an entry.

12. The method of claim 11, wherein the receiving step further comprises:
receiving at least one declaration written in a framework language that expresses at least one abstract security principle, wherein the at least one declaration further declares the access right in terms of kernel objects.

13. The method of claim 1, wherein prior to the receiving step the method further comprises:
receiving a resource definition that defines an abstract security principle in terms of at least one kernel object.

14. A computer program product comprising a computer usable medium having control logic stored therein for developing a security-enhanced application that runs on a flexible and configurable mandatory access control (MAC) operating system, wherein the security-enhanced application separates information resources from processes and processes from each other, and wherein the security-enhanced application includes a set of rules that control information flow between the information resources and processes, the control logic comprising:
first computer readable program code that causes the computer to receive input from a user that expresses at least one abstract security principle; and
second computer readable program code that causes the computer to translate the input into policy language using a framework dictionary, wherein the policy language specifies a policy that determines allowed access for the flexible and configurable MAC operating system.

15. The computer program product of claim 14, wherein the first computer readable program code comprises:
code that causes the computer to receive a graphical depiction of the at least one abstract security principle.

16. The computer program product of claim 14, wherein the first computer readable program code comprises:
code that causes the computer to receive at least one declaration written in a framework language that expresses the at least one abstract security principle.

17. The computer program product of claim 14, wherein the first computer readable program code comprises:
code that causes the computer to receive at least one declaration written in a framework language that expresses at least one abstract security principle, wherein the at least one declaration declares a domain which represents a security boundary.

18. The computer program product of claim 17, wherein the first computer readable program code further comprises:
code that causes the computer to receive at least one declaration written in a framework language that expresses at least one abstract security principle, wherein the at least one declaration further declares the domain in terms of at least one kernel object.

19. The computer program product of claim 18, wherein the first computer readable program code further comprises:
code that causes the computer to receive at least one declaration written in a framework language that expresses at least one abstract security principle, wherein the at least one declaration further declares a sub-domain which is constrained by (i) a subset of the at least one kernel object declared for the domain and (ii) access rights granted to the domain.

20. The computer program product of claim 14, wherein the first computer readable program code comprises:
code that causes the computer to receive at least one declaration written in a framework language that expresses at least one abstract security principle, wherein the at least one declaration declares a base domain which represents a security boundary.

21. The computer program product of claim 14, wherein the first computer readable program code comprises:
code that causes the computer to receive at least one declaration written in a framework language that expresses at least one abstract security principle, wherein the at least one declaration declares a shared resource which allows a first domain to interact with a second domain.

22. The computer program product of claim 21, wherein the first computer readable program code further comprises:
code that causes the computer to receive at least one declaration written in a framework language that expresses at least one abstract security principle, wherein the at least one declaration further declares the shared resource in terms of at least one kernel object.

23. The computer program product of claim 14, wherein the first computer readable program code comprises:
code that causes the computer to receive at least one declaration written in a framework language that expresses at least one abstract security principle, wherein the at least one declaration declares a base resource which allows a first domain to interact with a second domain.

24. The computer program product of claim 14, wherein the first computer readable program code comprises:
code that causes the computer to receive at least one declaration written in a framework language that expresses at least one abstract security principle, wherein the at least one declaration declares an access right which specifies a general kind of connection between a domain and a shared resource, wherein the general kind of connection includes at least one of a read, a write, or an entry.

25. The computer program product of claim 24, wherein the first computer readable program code further comprises:
code that causes the computer to receive at least one declaration written in a framework language that expresses at least one abstract security principle, wherein the at least one declaration further declares the access right in terms of kernel objects.

26. The computer program product of claim 14, further comprising:
third computer readable program code that causes the computer to receive a resource definition that defines an abstract security principle in terms of at least one kernel object.
